(19) United States
(12) Patent Application Publication
(10) Pub. No.: US 2009/0126206 A1
(43) Pub. Date: May 21, 2009

(54) Circular Saw With Cutting Depth Display

(76) Inventors: Ka Wai Chung, Tuen Mun (HK); Rong Chen, Dongguan City (CN); Ling Li, Dongguan City (CN); Zi Qiang Cao, Dongguan City (CN)

Correspondence Address: MICHAEL, BEST & FRIEDRICH LLP, 100 EAST WISCONSIN AVENUE, SUITE 3300, MILWAUKEE, WI, 53202, US

(21) Appl. No.: 11/941,343

(22) Filed: Nov. 16, 2007

(51) Int. Cl. B27B 9/02

(52) U.S. Cl. 30/376

(57) ABSTRACT

A circular saw is provided with a saw blade, a saw blade guard, and an adjustment bracket connected to a base plate to selectively adjust the base plate with respect to the saw blade, wherein a portion of the adjustment bracket is visible through at least a portion of the saw blade guard.

### BACKGROUND

This invention relates to portable circular saws and in particular to a display for indicating a saw's cutting depth.

Circular saws with adjustable cutting depths are known. They typically include a bracket mounted to the top surface of a pivotable base plate. Once a desired cutting depth has been established, the base plate and bracket may be locked with respect to the circular saw. These brackets, however, add additional members to the exterior of the circular saw and can decrease the visibility around the circular saw and work piece.

Circular saws with adjustable cutting depths commonly include a gauge to assist with the selection of a desired cutting depth. These gauges are usually provided on the bracket and consist of a series of indicators. Although these gauges may satisfactorily assist the selection of a cutting depth, they can be improved.

It is thus an object of the present invention to provide an easy to read cutting depth display for a circular saw.

### BRIEF SUMMARY

The present invention provides a circular saw with a cutting depth display. The circular saw includes a base plate, a motor adapted to rotate a saw blade, and a saw blade guard. The circular saw also includes an adjustment bracket connected to the base plate. The adjustment bracket extends from the base plate into the saw blade guard and has a curved shape similar to that of the saw blade guard. Indicia are provided on the bracket and they correspond to the saw's cutting depth. At least a portion of the adjustment bracket, and, in particular, a portion of the indicia, is visible through the saw blade guard, such as through a window. The saw blade guard also includes an indicator near the window for accurate selection of a desired cutting depth. Once the base plate is pivoted to a desired cutting depth, as indicated by the indicia on the adjustment bracket, a lock on the saw blade guard may be used to lock the adjustment bracket to the saw blade guard and thus the position of the base plate with respect to the saw blade.

### BRIEF DESCRIPTION OF THE DRAWINGS

FIG. 1 is a perspective rear side view of a circular saw incorporating the cutting depth display of the present invention.

FIG. 2 is a perspective front side view of the circular saw of FIG. 1.

FIG. 3 is a perspective front side view of the circular saw of FIG. 1 with a shell of the saw blade guard removed and other structure removed to better illustrate details of the present invention.

FIG. 4 is a perspective rear side view of the circular saw of FIG. 3.

FIG. 5 is a rear view of the circular saw of FIG. 1.

### DESCRIPTION OF THE PREFERRED EMBODIMENTS

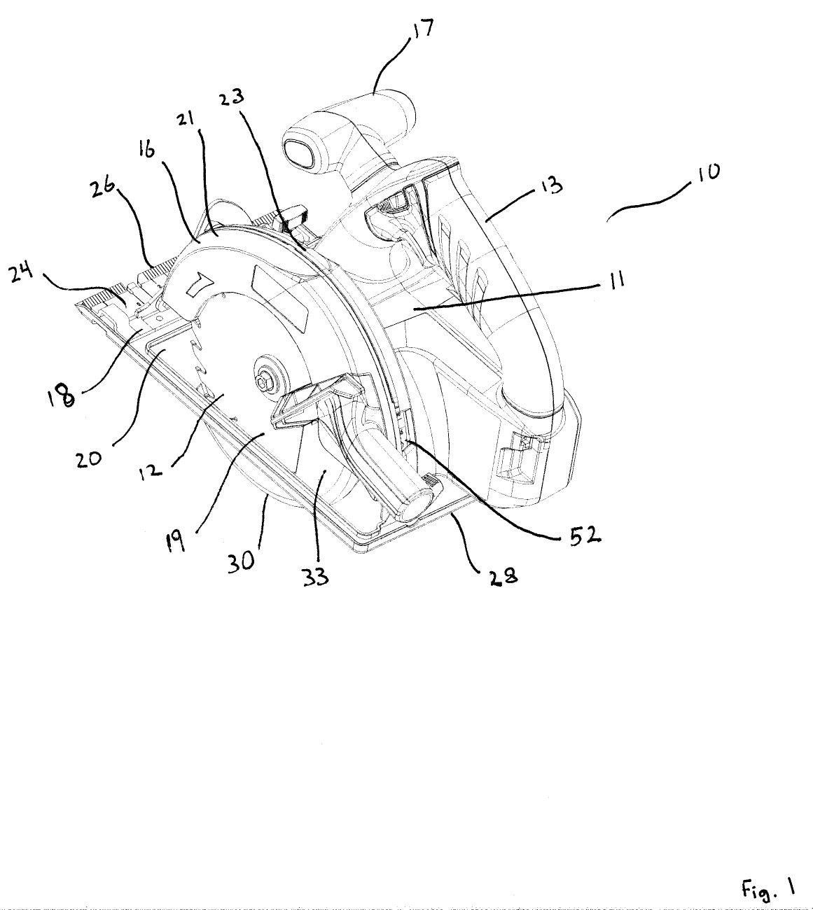

FIG. 1 shows a conventional circular saw 10. The saw 10 includes a housing 11 enclosing a motor 14 that drives a saw blade 12. A saw blade guard 16 and a base plate 18 are also associated with the housing 11. The housing 11 includes a handle 13 having a configuration suitable to be gripped. A power switch or trigger 15 is used to activate the motor 14 enclosed by the housing 11. An auxiliary handle 17 extends from a forward end of the main handle 13 and can be gripped by a hand different from that gripping the main handle 13. The base plate 18 includes a slot 20 and has a bottom surface 22, a top surface 24, a front end 26, and a rear end 28. The housing 11 is connected to the top surface 24 of the base plate 18 and is movable relative to the base plate 18. The saw blade 12 is rotatably attached to the motor 14 such that a portion of saw blade 12 extends down through the slot 20 on the base plate 18 to define a cutting depth 30. The saw blade guard 16 is immovably connected to the housing 11 and covers an upper portion of the saw blade 12. A lower blade guard 33 is mounted about a lower portion 19 of the saw blade 12 and can be moved from an open position, where the blade 12 is exposed, to a closed position, where the blade 12 is covered.

The saw blade guard 16 may include a first shell 21 and a second shell 23. The first shell 21 mates with second shell 23 and when connected surround an upper edge portion 25 of the saw blade 12. The inner portion 27 of each shell has a channel 29 to receive the adjustment bracket 34, as explained below. The mated shells form an aperture 31 on the saw blade guard 16 to receive a locking member 40, as explained below. The first shell 21 or the second shell 23 may also have a window 52.

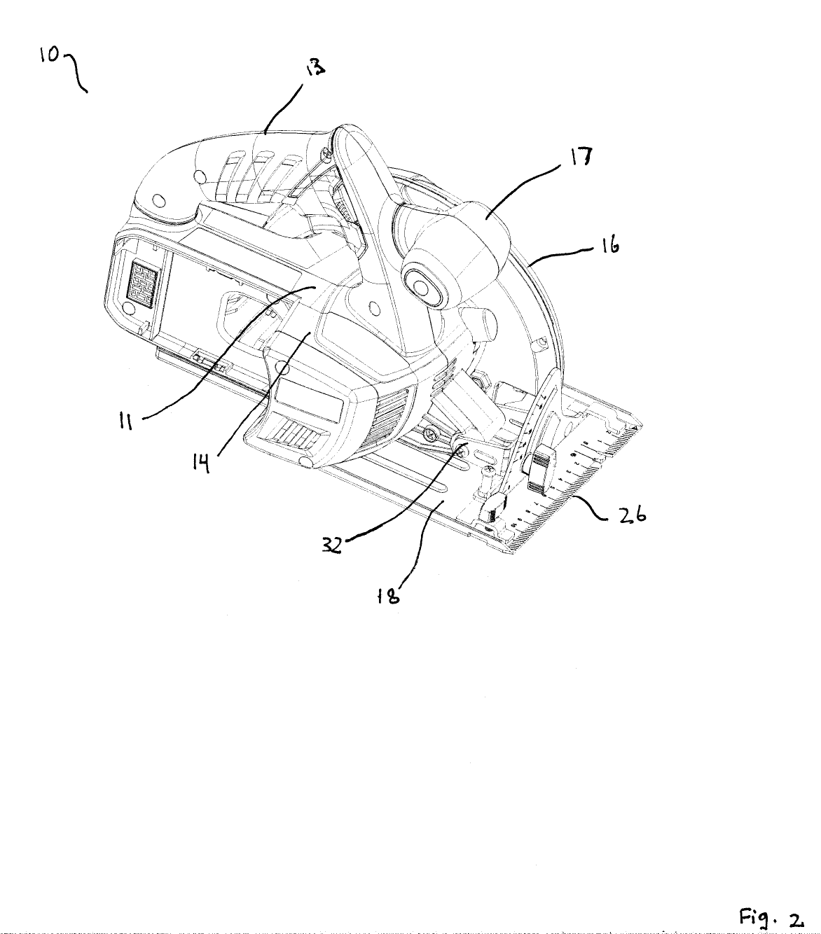

The circular saw 10 provides for an adjustable cutting depth 30. As best seen in FIG. 2, the front end 26 of the base plate 18 is attached to the housing 11 by a pivot member 32. As the base plate 18 is pivoted with respect to the housing 11, the rear end 28 of the base plate 18 pivots with respect to the saw blade 12, which changes the extent of the portion of the saw blade 12 that extends through the slot 20. During this adjustment, the housing 11, saw blade 12, and saw blade guard 16 are stationary with respect to one another.

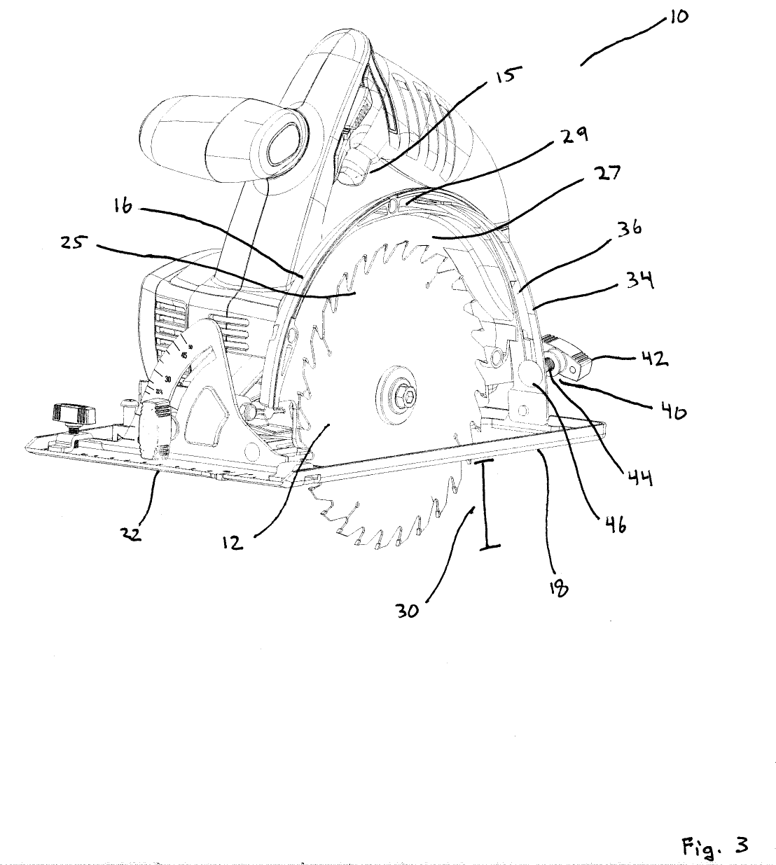

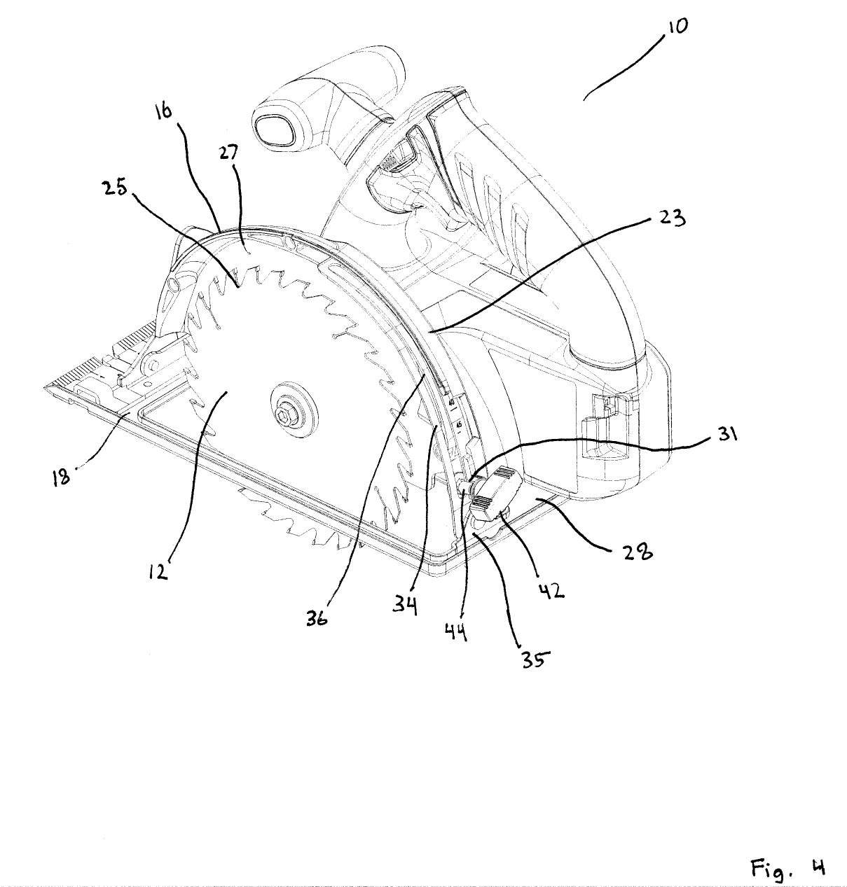

Turning to FIG. 3 and FIG. 4, the circular saw 10 includes an adjustment bracket 34 at the rear end 28 of the base plate 18 for locking the base plate 18 in a desired position. Extending upward from the top surface 24 of the base plate 18 is an ear 35 to which one end of the adjustment bracket 34 is mounted. The adjustment bracket 34 extends from the ear 35 on the base plate 18 upward into the saw blade guard 16. In particular, the adjustment bracket 34 extends upward into the channel 29 and is separated from the saw blade 12. The adjustment bracket 34 has approximately the same curvature of the saw blade guard 16 and the channel 29 so that the adjustment bracket 34 pivots with the base plate 18 without substantial contact or resistance from saw blade guard 16. Running substantially the entire length of the adjustment bracket 34 is a slot 36 for receiving a screw 44 of a lock member 40.

Once a desired position of the base plate 18 has been established, the lock member 40 located on the saw blade guard 16 may be used to lock the position of the base plate 18 with respect to the saw blade 12. As shown, the lock member 40 may consist of a knob and screw type fastener. It is contemplated, however, that other locking mechanisms may be used. The knob 42 is attached to a screw 44 that extends through the aperture 31 on the saw blade guard 16 and the slot 36 on the adjustment bracket 34. The screw 44 has a head 46 opposite the knob 42 for engaging the adjustment bracket 34. Depending on the direction the knob 42 is rotated, the head 46 either extends away from or retracts toward the adjustment bracket 34. Rotation of the knob 40 so that the head 46 retracts locks the position of the saw blade 12 with respect to the base plate 18 by tightly engaging and compressing the head 46 against the adjustment bracket 34 and the blade guard 16. Rotation of the knob 40 so that the head 46 extends away from the adjustment bracket 34 unlocks the position of the saw blade 12 and permits adjustment of the cutting depth 30. In other words, the extent to which the portion of the saw blade 12 extends through the slot 20 and away from the bottom surface 22 of the base plate 18 may be adjusted.

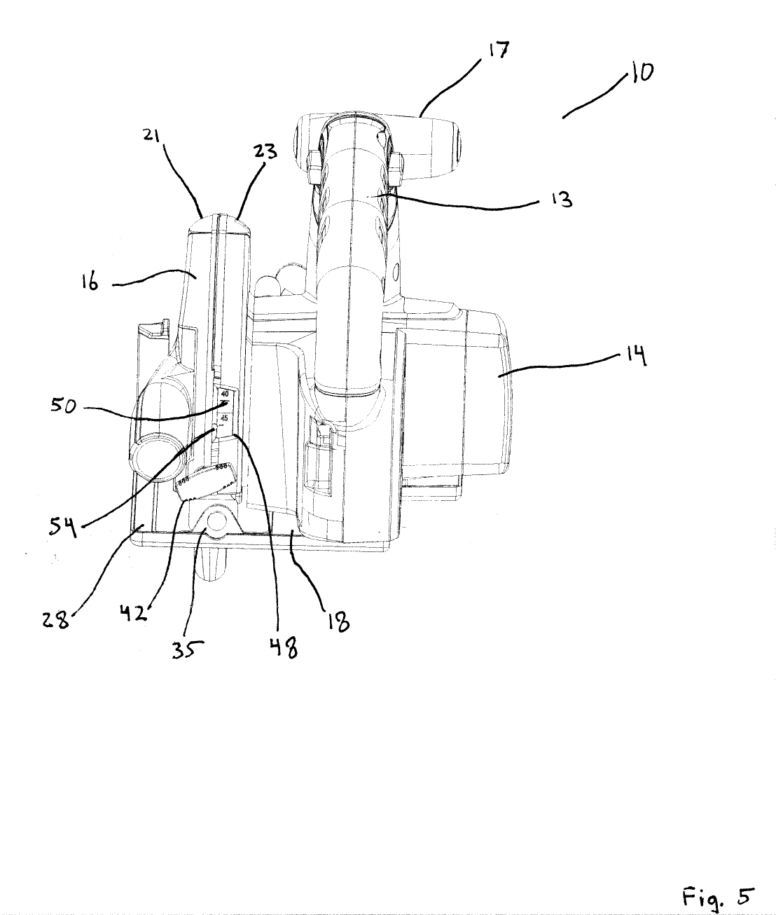

Turning to FIG. 5, the circular saw 10 also provides a cutting depth display 48. Located on a side of the adjustment bracket 34 are indicia 50 to facilitate the selection of a cutting depth 30. A window 52 may be provided through the saw blade guard 16 and, in particular, through shell 21 or shell 23, so that a portion of the adjustment bracket 34 is visible through the saw blade guard 16, particularly the portion containing the indicia 50. An indicator 54 may also be provided on the saw blade guard 16, such as on the shell 21 or shell 23, so that a cutting depth 30 may be accurately selected. The indicator 54 is associated with the indicia 50 so that as the base plate 18, and thus the adjustment bracket 34, moves with respect to the saw blade guard 16 and the saw blade 12, the depth of the saw blade 12 is quickly and easily shown and visible.

Accordingly, the cutting depth 30 of the circular saw 10 may be adjusted by first rotating the knob 42 in a direction that extends the head 46 on the screw 44 away from the adjustment bracket 34. Once the base plate 18 is unlocked and free to pivot, the base plate 18 is moved with respect to the housing 11 while the indicia 50 may be viewed to provide an indication that a desired cutting depth 30 has been achieved. The base plate 18 may be locked at the desired cutting depth by rotating the knob 42 in the opposite direction to engage and compress the head 46 against the adjustment bracket 34 and the saw blade guard 16.

Thus, the present invention provides a cutting depth display for circular saws permitting easy adjustment and selection of a desired cutting depth. The foregoing description of the invention has been presented for purposes of illustration and description, and is not intended to be exhaustive or to limit the invention to the precise form disclosed. It will be apparent to those skilled in the art that the present invention is susceptible of many variations and modifications coming within the scope of the following claims.

What is claimed is:

1. A circular saw having a depth of cut indicator comprising:
a. a saw blade;
b. a motor adapted to rotate the saw blade;
c. a saw blade guard covering at least a portion of the saw blade and formed with an aperture;
d. a base plate;
e. an adjustment bracket having one end connected to the base plate and having a slot substantially the entire length of the adjustment bracket; and,
f. a locking member extending through the aperture and slot to selectively adjust the base plate with respect to the saw blade, wherein a portion of the adjustment bracket is visible through at least a portion of the saw blade guard.

2. The circular saw according to claim 1, wherein at least a portion of the adjustment bracket is located between the saw blade and the saw blade guard.

3. The circular saw according to claim 1, wherein the portion of the adjustment bracket is visible through a window on the saw blade guard.

4. The circular saw according to claim 3, further comprising indicia located on the adjustment bracket.

5. The circular saw according to claim 4, wherein a portion of the indicia is visible through the window.

6. The circular saw according to claim 5, further comprising an indicator on the saw blade guard.

7. The circular saw according to claim 6, wherein the indicator is associated with the indicia to provide an indication of an extent to which the saw blade extends through the slot on the base plate.
